(19) United States
(12) Patent Application Publication
(10) Pub. No.: US 2007/0093280 A1
(43) Pub. Date: Apr. 26, 2007

(54) Mobile power distribution system and method thereof

(76) Inventor: Christopher Andrew McKay, Waterbury, VT (US)

Correspondence Address: NORTHERN POWER SYSTEMS, INC., 10 TECHNOLOGY DRIVE, WALLINGFORD, CT, 06492, US

(21) Appl. No.: 11/257,237

(22) Filed: Oct. 24, 2005

(51) Int. Cl. H04B 1/38

(52) U.S. Cl. 455/574

(57) ABSTRACT

A self contained mobile power conversion station including a mobile support platform for moving the station from a first location to a second location. A plurality of solid state power converters are mounted to the mobile support platform and have an input for receiving raw electrical power and an output for producing regulated electrical power. A heat exchanger is mounted to the mobile support platform and is coupled to the plurality of solid state power converters for removing heat during operation. A power inlet mounted is provided on the mobile support platform and is coupled to the inputs on the power converters. A power outlet mounted to the mobile support platform and to the plurality of power converter outlets for transmitting said regulated electrical power to one or more end use loads.

### FIELD OF INVENTION

This disclosure relates generally to a system for providing electrical power and power conversion functionality in parallel with the utility services and especially to a system for a supplying multiple asynchronous electric power outputs from a single common electrical generation system.

### BACKGROUND OF THE INVENTION

Electrical power is distributed from large generation stations to end users through a network or grid of interconnected transmission lines. While the transmission system is interconnected at multiple points, during times of high electrical usage, or unexpected fault conditions, the utility company may be unable to deliver sufficient electrical power to users on some sections of the network. This condition may exist, for example, due to bottlenecks in the electrical distribution system created by the failure to expand capacity with the growth and development of a geographic area.

During these periods of low electrical power availability, customers may experience a phenomenon known as a “brown-out” or a “black-out.” During a black-out, the customer experiences a total loss of electrical power. In a brown-out condition some electrical supply is retained, however the transmitted voltage is less than the allowable specification for the transmission network. Either situation will cause disruption to the end-user operations.

To temporarily resolve power availability issues, utilities and electrical transmission companies have resorted to using portable power generators that may be moved and connected to the electrical network on a temporary basis. These portable generators are usually large diesel generators housed on a flatbed trailer. Coupled to these generators are transformers that allow the output of the diesel generator to have the proper characteristics to match those of the network that it is being connected. Typically the transformers are housed on a separate flatbed trailer to allow the mixing and matching of equipment. These systems will also have additional equipment that provides feedback to the generator controls that allows the electrical output to be synchronized with the electrical network.

While this system of portable generation has provided emergency network power support, its application is limited by the systems ability to connect and synchronize with the electrical network. The portable generation system also has shortfalls when multiple electrical outputs are required, for example, where power is needed at a facility for critical load support where the facility has loads having different power requirements. While existing portable power systems are suitable for their intended purposes, there still remains a need for improvements in providing flexible power conversion systems that allows the achievement of appropriate levels of power quality, efficiency and reliability required for the end use loads. There is also a need for a portable generation system for supplying electrical power to multiple loads having asynchronous power characteristics. Further, there is a need for capturing heat from the portable generation system for use by a supported facility.

### SUMMARY OF THE INVENTION

The present invention provides a system for a self contained mobile power conversion station including a mobile support means for moving the station from a first location to a second location. A plurality of solid state power converters are mounted to the mobile support means and have an input for receiving raw electrical power and an output for producing regulated electrical power. A heat exchanger is mounted to the mobile support means and is coupled to the plurality of solid state power converters for removing heat during operation. A power inlet is mounted to the mobile support means and is coupled to the inputs on the power converters. A power outlet is mounted to the mobile support means and is coupled to the plurality of power converter outlets for transmitting the regulated electrical power to one or more end use loads.

The present invention also provides for a mobile power station having a first mobile support with an electrical power generator. A second mobile support houses a plurality of solid state power converters where each of the power converters has an input electrically connected to the electrical power generator. Finally a third mobile support having a first electrical transformer is provided where the first transformer has an electrical input coupled to an output on at least one of the plurality of power converters. The first transformer is configured to output electrical power at a first predetermined set of characteristics.

The mobile power station may also include a controller coupled to the plurality of solid state power converters where the controller has a user interface being configured to display predetermined operational parameters. The controller further includes a user activation means coupled to the controller, wherein there is exchange of data flow between the controller and the user activation means. The user activation means also comprises data receiving means adapted to receive data from transfer means selected from the group consisting of an electronic data card, voice activation means, manually-operable selection and control means, radiated wavelength and electronic or electrical transfer.

The mobile power stations controller is also programmed for receiving a first signal from one of the plurality of power converters. The controller will retrieve a first operational parameter and a predetermined variance from a memory device electrically coupled to the controller and compares the first operational parameter to the first signal. A second signal is provided to the plurality of power converters and a third signal to the computer network wherein the controller and the memory device are operably coupled to a remote computer and the remote computer is configured to provide the first operation parameter to the memory device.

Finally, an integrated mobile power station is provided that includes a movable support structure having a generator mounted thereon. A plurality of solid state power converters is also mounted to the movable support structure where each has an input electrically coupled to the generator and an output wherein each of the plurality of solid state power converter outputs has a different electrical power characteristic. A heat exchanger is also mounted to the moveable support structure and fluidly coupled to the plurality of power converters.

The above discussed and other features will be appreciated and understood by those skilled in the art from the following detailed description and drawings.

### BRIEF DESCRIPTION OF THE DRAWINGS

Referring now to the drawings, which are meant to be exemplary and not limiting, and wherein like elements are numbered alike:

FIG. 1 is an illustration in perspective view of an exemplary embodiment portable power conversion system;

FIG. 2 is a schematic illustration of a portable power generation and conversion system utilizing a single auxiliary generator to provide power to a utility electrical network;

FIG. 3 is a schematic illustration of an alternate embodiment portable power generation and conversion system to provide electrical power to multiple asynchronous loads;

FIG. 4 is a schematic illustration of an alternate embodiment portable power generation and conversion system including a means for utilizing heat from the system in a facility;

FIG. 5 is a schematic illustration of an integrated portable power generation system; and,

FIG. 6 is a schematic illustration of a controller used in a portable power and conversion system.

### DESCRIPTION OF PREFERRED EMBODIMENT

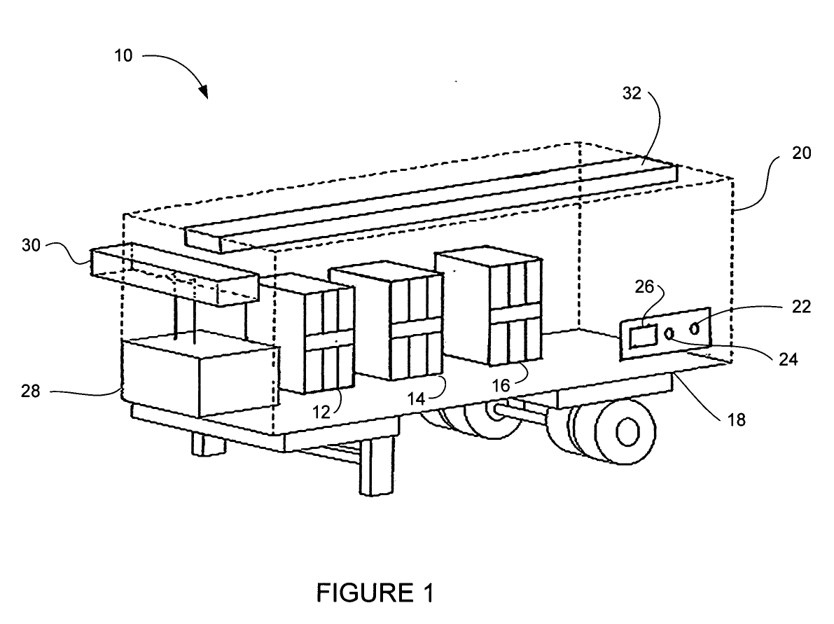

Traditionally, electrical power distribution and service was provided by a single utility which would provide all services required by a user, from the generation of the electricity, to the maintaining of the electrical grid. As the electrical power industry was deregulated, complexities often arose as consumers were allowed to purchase electricity from multiple suppliers over a transmission system owned by a third party. At the same time that deregulation has been implemented, customer power needs were increasing. Since the return on investment was uncertain, capital investments in the transmission systems were suppressed or delayed, thus creating bottlenecks in the electrical transmission network. These power deficiency bottlenecks are especially evident during periods of peak demand. To compensate for these deficiencies and to provide improvements in the cost effectiveness, reliability and maintenance of portable power generation, the present invention provides a mobile power generation and conversion system as shown in FIGS. 1-6.

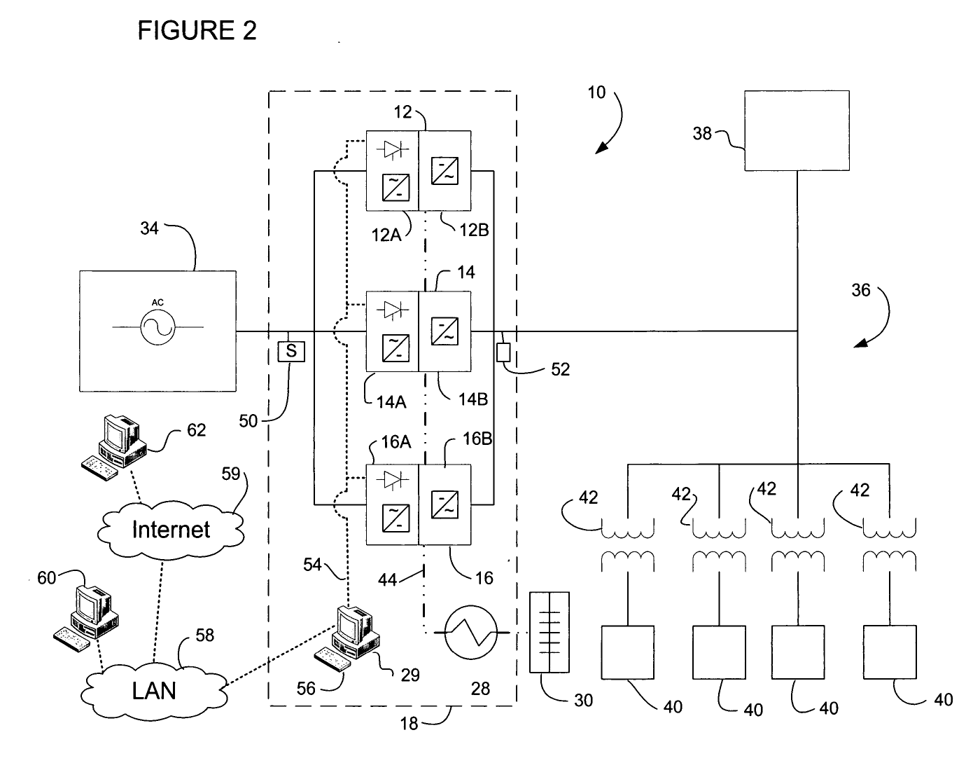

An exemplary embodiment of the present invention is shown in FIG. 1. In this embodiment, a power conversion system 10, includes a series of solid state power converters 12, 14, 16 which receive alternating current (AC) electrical power from a generator 34, such as a diesel generator (FIG. 2). The power converters 12-16 are mounted on a mobile support platform 18, which may optionally include a housing 20 for sheltering the power converters 12-16. System 10 will further include a power inlet 22 and a power outlet 24 along with a user interface 26 and a controller 29. In the preferred embodiment, the inlet 22, outlet 24 and interface 26 are co-located on one side of the platform 18 to provide the user with capability of stationing the system 10 adjacent a building while still providing easy access to the electrical connections and monitoring units.

As used herein, the mobile support platform includes, but is not limited to platforms, pallets, skids, rail cars and trailers for mounting the various pieces of power generation and conversion systems. The mobile support platform may be mounted on self-propelled transportation means (e.g. trucks, tractor-trailers, aircraft, or ships) or on transportation means which must be moved by separate locomotion (e.g. rail cars, trailers, barges, transportable skids and the like).

A heat exchanger 28 having an external radiator 30 is coupled to each of the power converters 12-16. Heat exchanger 28 provides a cooling fluid to heat exchanger internal to each power converter (not shown) to remove heat generated during operation. As will be discussed in more detail below, this heat may be reclaimed for further use. An optional hoist 32 to mounted to the roof of the housing 20 to facilitate the quick installation and removal of power converters 12-16 from the mobile platform 18.

Referring now to FIG. 2, the system 10 is shown incorporated into an electrical power network application. An electrical generator 34 produces electrical power to be used on a network 36. The generator 34 is preferably a multi-megawatt scale generator capable of producing 60 Hz AC electrical power. More preferably, the generator 34 is a 2 MW, three-phase, diesel generator. However, the generator 34 may also produce electrical power have other characteristics including, but not limited to 50 Hz or 400 Hz frequency, single phase waveform, 480V, 220V or 110V. The generator 34 may be any type of distributed power generation device, including but not limited to electrical generators powered by hydrocarbon fueled (i.e. diesel, gasoline, propane or natural gas) internal combustion engines, hydrogen internal combustion engines, external combustion engines, Stirling engines, microturbines, steam turbines, gas turbines, flywheels, wind turbines, photovoltaic arrays, batteries, fuel cells (i.e. polymer electrode membrane, solid oxide, molten-carbonate, or phosphoric acid), capacitors, super-capacitors and ultracapacitors. In the exemplary embodiment, the generator 34 is mounted to a mobile platform separate from the power conversion system 10.

The electrical power from generator 34 is transmitted to the conversion system 10 through the inlet 22 where it is distributed to each of the solid state power converters 12-16. In the exemplary embodiment the power converters 12-16 are similar to that described in U.S. Pat. No. 6,693,409 entitled “Control system for a power converter and method of controlling operation of a power converter” which is incorporated herein by reference. The power converters 12-16 may be of any type that can manage electrical characteristics such as, but not limited to, AC frequency, phase or voltage on either side of the converter and control the power flow at the same time. Preferably, the power converters 12-16 will automatically and independently adjust the electrical characteristics of the asynchronous electrical power produced by generator 34 to be compatible with the connected load and utility. In addition the power converters 12-16 preferably can control the reactive power on each side independently making possible some amount of voltage control on either side of the converter. This arrangement provides a number of advantages over the prior art systems in that this embodiment allows the generator 34 to operate in variable speed generator (“VSG”) mode to achieve improved performance and efficiency at partial loads. The VSG mode allows for operation during step changes in the load demand and the utilization of the rotational inertia of the generator 34 in compensating for these step changes.

In the exemplary embodiment, the each power converter 12-16 contains two sections 12A, 12B, 14A, 14B, 16A, 16B to perform the power conversion. The “A” side of each power converter 12A, 14A, 16A rectifies the incoming AC power from the generator 34 to produce a desired direct current (DC) electrical power. The rectifiers 12A, 14A, 16A remove inherent power quality issues in the AC waveform created by the generator 34. The DC power is passed from the rectifiers 12A, 14A, 16A to an inverter 12B, 14B, 16B that generates AC power with the appropriate characteristics needed by the electrical network 36. In the preferred embodiment, each power converter 12-16 outputs regulated electrical power at 900 kVA with a voltage of 480V. The regulated electrical power exits the system 10 through the outlet 24 where it is carried by the electrical network 36 to end use loads 38, 40. It should be appreciated that electrical network 36 may include transformers that are more or less permanently affixed to the network 36 and provide addition power regulation prior to distribution to end use loads 40.

Each of the power converters 12-16 is coupled to the heat exchanger 28 through at least a pair of conduits 44 that carry a cooling fluid such as water or glycol to each converter 12-16 where it passes through an internal heat exchanger. The cooling fluid absorbs heat in the internal heat exchanger and transports the heat back through the conduit 44 to the heat exchanger 28 which cools the fluid in the radiator 30 before circulating it back to the power converters 12-16.

The heat exchanger 28 operation is controlled by controller 29. Controller 26 is a suitable electronic device capable of accepting data and instructions, executing the instructions to process the data, and presenting the results. Controller 29 may accept instructions through user interface 26, or through other means such as but not limited to electronic data card, voice activation means, manually-operable selection and control means, radiated wavelength and electronic or electrical transfer. Therefore, controller 26 can be a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, a scientific computer, a scientific calculator, or a hybrid of any of the foregoing.

Controller 29 is capable of converting the analog voltage or current level provided by sensors 50, 52 into a digital signal indicative of the electrical input from the generator 34 and output from the conversion system 10. Alternatively, sensors 50, 52 may be configured to provide a digital signal to controller 26 , or an analog-to-digital (A/D) converter (not shown) maybe coupled between sensors 50, 52 and controller 26 to convert the analog signal provided by sensors 50, 52 into a digital signal for processing by controller 26. Controller 29 uses the digital signals act as input to various processes for controlling the system 10. The digital signals represent one or more system 10 data including but not limited to generator voltage, generator current, generator fuel supply, power converter temperature, power converter output voltage, power converter output current, or load power requirements.

Controller 29 is operably coupled with one or more components of system 10 by data transmission media 54. Data transmission media 54 includes, but is not limited to, twisted pair wiring, coaxial cable, and fiber optic cable. Data transmission media 54 also includes, but is not limited to, wireless, radio and infrared signal transmission systems. In the embodiment shown in FIG. 2, transmission media 54 couples controller 29 to power converters 12-16, sensors 50, 52, and heat exchanger 28. Controller 29 is configured to provide operating signals to these components and to receive data from these components via data transmission media 54.

In general, controller 29 accepts data from sensor 50, 52 and power converters 12-15 , is given certain instructions for the purpose of comparing the data from sensors 50, 52 and power converters 12-16 to predetermined parameters. Controller 29 provides operating signals to power converters 12-16 and heat exchanger 28. Controller 29 also accepts data from heat exchanger 28, indicating, for example, whether the power converters are operating in the correct temperature range. The controller 29 compares the operational parameters to predetermined variances (e.g. high temperature range) and if the predetermined variance is exceeded, generates a signal that may be used to indicate an alarm to an operator or the computer network. Alternatively, the signal may initiate other control methods that adapt the operation of the system 10 to compensate for the out of variance operating parameter. For example, a high cooling fluid temperature returning from one of the power converter 12 may indicate an issue with that power converter 12. To prevent damage to the equipment, the controller 29 may initiate a shut-down of the power converter 12. In the preferred embodiment, the individual converters 12-16 would have capacity to accept the additional load created by a loss of a single power converter, enabling full operation of the system 10.

The data received from sensors 50, 52, power converters 12-16 and heat exchanger 28 may be displayed on user interface 26, which is coupled to controller 29. User interface 26 is an LED (light-emitting diode) display, an LCD (liquid-crystal diode) display, a CRT (cathode ray tube) display, or the like. A keypad 56 is coupled to user interface 26 for providing data input to controller 29.

In addition to being coupled to one or more components within system 10, controller 29 may also be coupled to external computer networks such as a local area network (LAN) 58 and the Internet. LAN 58 interconnects one or more remote computers 60, which are configured to communicate with controller 29 using a well-known computer communications protocol such as TCP/IP (Transmission Control Protocol/Internet(ˆ) Protocol), RS-232, ModBus, and the like. Additional systems 10 may also be connected to LAN 58 with the controllers 29 in each of these systems 10 being configured to send and receive data to and from remote computers 60 and other systems 10. LAN 58 is connected to the Internet 59. This connection allows controller 29 to communicate with one or more remote computers 62 connected to the Internet 58.

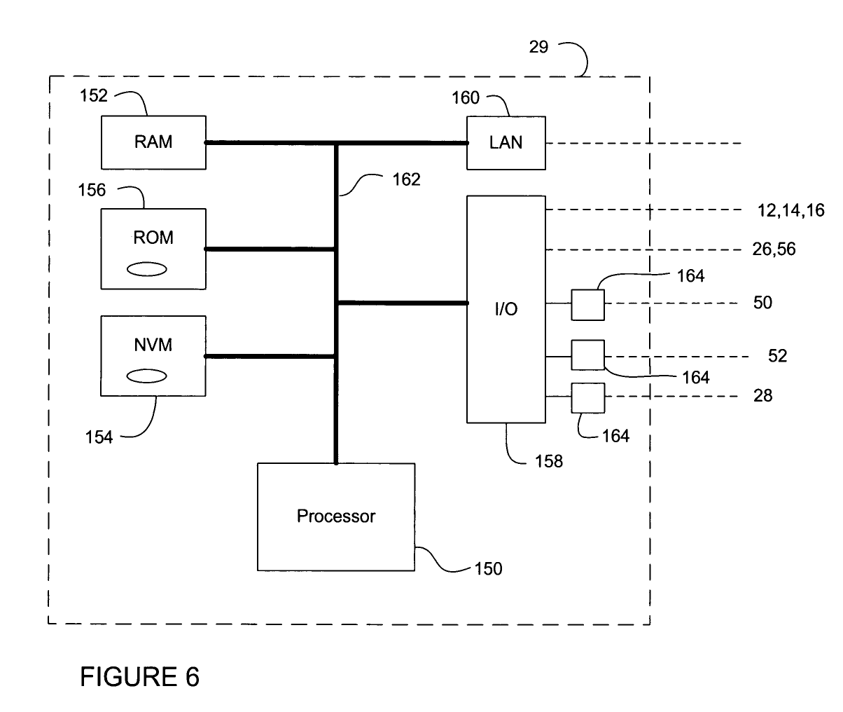

Referring now to FIG. 6 , a schematic diagram of controller 29 is shown. Controller 29 includes a processor 150 coupled to a random access memory (RAM) device 152, a non-volatile memory (NVM) device 154, a read-only memory (ROM) device 156, one or more input/output (I/O) controllers 158 , and a LAN interface device 160 via a data communications bus 162.

I/O controllers 158 are coupled to power converters 12-16, keypad 56, and user interface 26 for providing digital data between these devices and bus 162. I/O controllers 158 are also coupled to analog-to-digital (A/D) converters 164, which receive analog data signals from sensors 50, 52 , and heat exchanger 28.

LAN interface device 160 provides for communication between controller 29 and LAN 58 in a data communications protocol supported by LAN 58. ROM device 156 stores an application code, e.g., main functionality firmware, including initializing parameters, and boot code, for processor 150. Application code also includes program instructions for causing processor 150 to execute any power conversion system operation control methods, including starting and stopping operation, monitoring predetermined operating parameters such as coolant fluid temperature, and generation of alarms. The application code creates an onboard telemetry system may be used to transmit operating information between the system 10 and a home terminal location and or/receiving locations while en route from the home terminal to a operating location. The information to be exchanged remote computers and the controller 29 include but are not limited to generator status, generator power output, input current, input voltage, power converter status, output voltage, output current, output power, load demands, coolant fluid temperature, geographic location, gps coordinates, and alarm status.

NVM device 154 is any form of non-volatile memory such as an EPROM (Erasable Programmable Read Only Memory) chip, a disk drive, or the like. Stored in NVM device 154 are various operational parameters for the application code. The various operational parameters can be input to NVM device 154 either locally, using keypad 56 or remote computer 60, or remotely via the Internet using remote computer 62. It will be recognized that application code can be stored in NVM device 154 rather than ROM device 156.

Controller 29 includes operation control methods embodied in application code. These methods are embodied in computer instructions written to be executed by processor 150, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software.

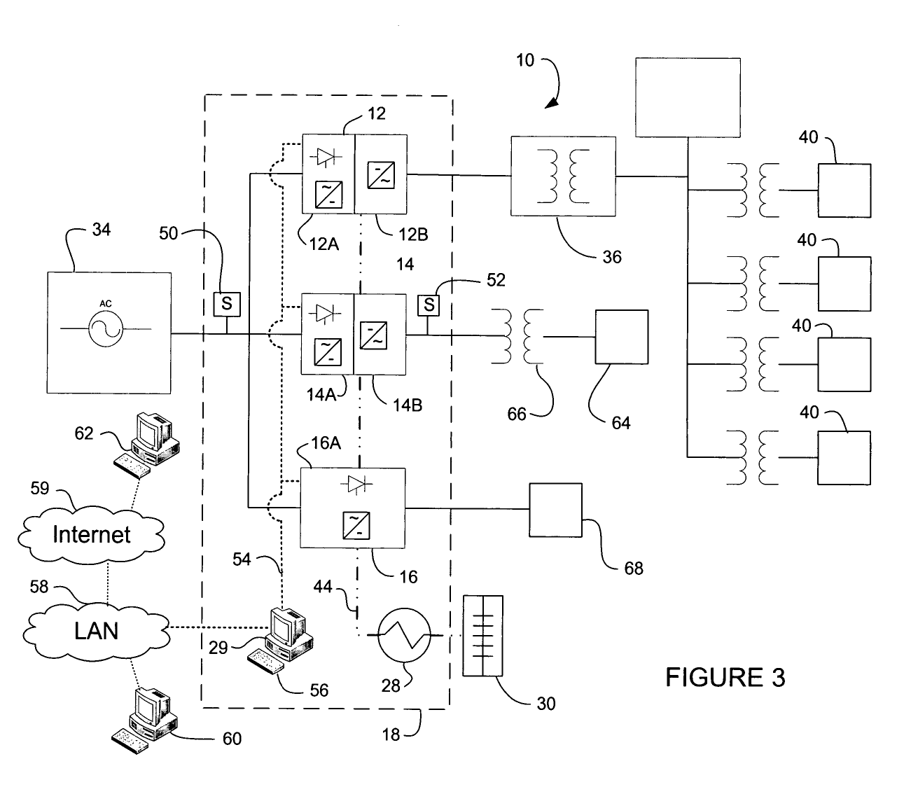

An alternate embodiment electrical power conversion system is shown in FIG. 3. In some applications, such as critical load support, it may be desirable to provide electrical power directly to a critical load rather than feeding the electrical power onto an electrical network. For example, if a generator 34 and power conversion system 10 are located at a telecommunications switching facility, there may be three distinct load requirements, 480V three phase to provide power to a network grid 36, 120V single phase to provide primary power to the telecommunications facility loads, and 48V DC power for the telecommunications equipment. In this embodiment, the power conversion system 10 is configured to provide different electrical outputs from each power converter 12-16. Here, the generator 34 provides AC electrical power onto a common bus that provides an input into each of the power converters 12-16. The first power converter 12 rectifies 12A the electricity and then inverts 12B to provide 3 phase regulated power as in the exemplary embodiment. This electrical power is output to the network 36 for use by the end use loads. The second power converter 14 rectifies 14A and inverts 14B only a single phase of the AC power generated by generator 34 to produce 220V AC electrical power for use directly by load 64. An optional transformer 66 may be incorporated to further vary the electrical characteristics of the output power from power converter 14.

Since loads 68, such as telecommunications equipment requires DC electrical power, power converter 16 is configured to provide only the rectifier 16A function to produce the necessary regulated power. This alternate embodiment provides several advantages over the prior art. In a typical prior art system, each load would have required a separate generator sized and configured to provide the electrical power type and characteristic needed by the end load. The additional generation systems would add significant cost, reliability and maintenance issues for the power producer.

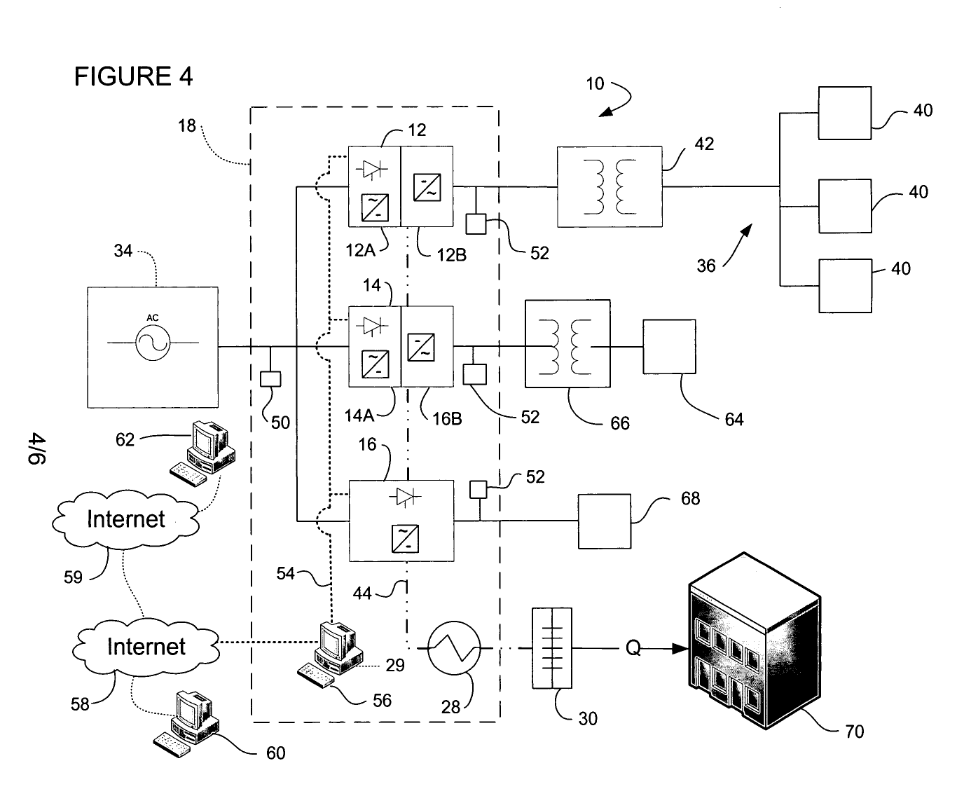

Another alternate embodiment is shown in FIG. 4. Here, the power converters are configured in the same manner as that illustrated in FIG. 3. Here, however, power conversion system 10 also reclaims the thermal energy Q produced by the power converters 12-16 to provide heat for heating of the facility 70. The thermal energy is typically transferred to the facility in the form of direct heat, hot water, or steam for process heating and/or cooling. It should also be appreciated that while the heat reclamation is shown with respect to power converters 12-16, it is also contemplated within the scope of this invention that heat may be captured from generator 34 to provide additional heat to facility 70.

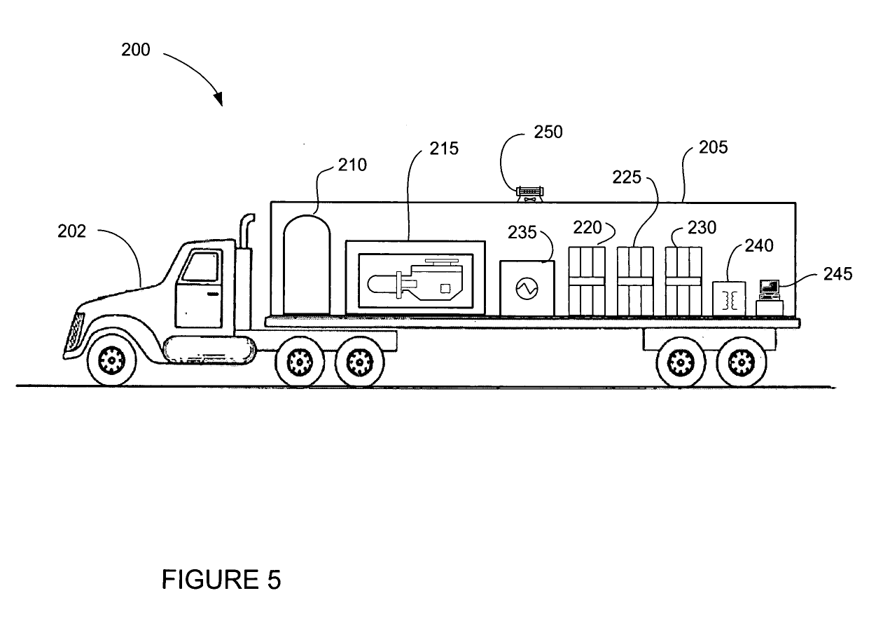

An alternate embodiment power generation and conversion system is shown in FIG. 5. This embodiment includes an integrated mobile platform 200 such as a tractor 202 and trailer 205 wherein the trailer provides the mobile support means for mounting an integrated power generation and conversion system. A storage tank 210 is provided to store fuel required to operate the generator 215. In the preferred embodiment, generator 215 includes a diesel fueled internal combustion engine that produces greater than 1 MW of 60 Hz three phase electrical power. More preferably, the generator produces at least 2 MW of 60 Hz three phase electrical power. However, the generator may be capable of producing power at other levels or with other characteristics, for example the electrical power may be produced at 50 Hz, 400 Hz, single phase, multi-phase or at different voltages including 480V, 220V, 110V. The generator 215 transfers the produced electrical power to a plurality of power converters 220-230 that convert and regulate the electrical power in the same manner as the described herein above in reference to FIGS. 2-4.

A heat exchanger 235 is coupled with both the generator 215 and the power converters 220-230 to remove heat during operation. In the exemplary embodiment, the cooling fluid from the heat exchanger 235 is transferred to a radiator 250, typically mounted on the roof of the trailer 205 where the heat is removed from the cooling fluid by the ambient air prior to returning to the heat exchanger 235 for reuse.

The integrated mobile platform 200 also includes a controller 245 having a user interface, a process and communications functionality as that described above. The controller 245 is coupled to the generator 215, storage tank 210, heat exchanger 235, and, power converters 220-230 to allow monitoring during operation and standby mode. An optional transformer 240 may be coupled to the power converters 220-230 to further adapt the output electrical power to the end user loads.

It should be noted that the integrated mobile platform 200 is illustrated in FIG. 5 installed on a closed trailer 205. This trailer 205 may include doors for providing access, or fitted with swing-out or swing-up sides to allow for operation and maintenance when necessary. If desired, the trailer 205 may also be an open flatbed trailer, rail car, barge, ship or aircraft.

While the invention has been described with reference to a preferred embodiment, it will be understood by those skilled in the art that various changes may be made and equivalents may be substituted for elements thereof without departing from the scope of the invention. In addition, any modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A self contained mobile power conversion station comprising:
a mobile support platform for moving the station from a first location to a second location;
a plurality of solid state power converters mounted to said mobile support platform, said power converters having an input for receiving raw electrical power and an output for producing regulated electrical power;
a heat exchanger mounted to said mobile support platform and operably coupled to said plurality of solid state power converters;
a power inlet mounted to said mobile support platform and said plurality of power converter inputs; and,
a power outlet mounted to said mobile support platform and coupled to said plurality of power converter outlets for transmitting said regulated electrical power.

2. The self contained mobile power conversion station of claim 1 wherein said plurality of power converters is comprised of a first power converter and a second power converter.

3. The self contained mobile power conversion station of claim 2 wherein said first power converter has a first raw electrical power input and a first regulated power output and said second power converter has a second raw electrical power input and a second regulated power output, wherein said first and second raw electrical power inputs are electrically coupled to said power inlet.

4. The self contained mobile power conversion station of claim 3 wherein said first power converter produces direct current electrical power.

5. The self contained mobile power conversion station of claim 4 wherein said second power converter produces alternating current electrical power.

6. The self contained mobile power conversion station of claim 1 further comprising a user interface mounted to said mobile support platform and electrically connected to said plurality of power converters.

7. The self contained mobile power conversion station of claim 6 further comprising a radiator fluidly coupled to said heat exchanger and mounted to said mobile support platform.

8. The self contained mobile power conversion station of claim 7 wherein said mobile support platform selected from the group consisting of trucks, trailers, tractor-trailers, rail cars, barges, ships, and aircraft.

9. A mobile power station comprising:
a first mobile support having an electrical power generator mounted thereon;
a second mobile support having a plurality of solid state power converters mounted thereon, said plurality of solid state power converters each having an input electrically connected to said electrical power generator;
a third mobile support having a first electrical transformer mounted thereon, said first transformer having an electrical input coupled to an output on at least one of said plurality of power converters and a load outlet, said first transformer configured to provide electrical power at a first predetermined set of characteristics.

10. The mobile power station of claim 9 wherein said plurality of solid state power converters is comprised of at least a first and second solid state power converter, said first power converter being electrically coupled to said first transformer.

11. The mobile power station of claim 10 further comprising a fourth mobile support having a second transformer electrically coupled to an output from said second power converter, said second transformer configured to provide electrical power at a second predetermined set of characteristics.

12. The mobile power station of claim 11 wherein said second predetermined set of characteristics is selected from the group consisting of DC-waveform, 24-volt DC power, 48-volt DC power, AC-waveform, 60 Hz AC-power, 50 Hz AC-power, 400 Hz AC-power, or 480-volt three phase AC-power.

13. The mobile power station of claim 9 further comprising:
a controller coupled to said plurality of solid state power converters, said user interface being configured to display predetermined operational parameters; and,
a user activation means coupled to said controller, wherein there is exchange of data flow between said controller and said user activation means.

14. The mobile power station of claim 13 wherein said user activation means comprises data receiving means adapted to receive data from transfer means selected from the group consisting of an electronic data card, voice activation means, manually-operable selection and control means, radiated wavelength and electronic or electrical transfer.

15. The mobile power station of claim 14 wherein said controller means comprises means for receiving and transmitting data selected from the group consisting of generator voltage, generator current, generator fuel supply, power converter temperature, power converter output voltage, power converter output current, geographic position or load power requirements.

16. The mobile power station of claim 14 wherein said controller includes communication means adapted for transmitting and receiving data from a computer network.

17. The mobile power station of claim 16 wherein said computer network is selected from the group consisting of the internet, a local area network, a wide area network, a cellular network, or a wireless network.

18. The mobile power station of claim 16 wherein said controller is programmed for:
receiving a first signal from one of said plurality of power converters;
retrieving a first operational parameter and a predetermined variance from a memory device electrically coupled to said controller;
comparing said first operational parameter to said first signal;
providing a second signal to said plurality of power converters;
providing a third signal to said computer network; and, wherein said controller and said memory device are operably coupled to a remote computer, said remote computer being configured to provide said first operation parameter to said memory device.

19. An integrated mobile power station comprising:
a movable support structure;
a generator mounted to said movable support structure;
a plurality of solid state power converters mounted to said movable support structure and having an input electrically coupled to said generator and an output, wherein each of said plurality of solid state power converter outputs has a different electrical power characteristic; and,
a heat exchanger mounted to said moveable support structure, said heat exchanger being fluidly coupled to said plurality of power converters.

20. The integrated mobile power station of claim 19 further comprising at least one transformer mounted to said movable support structure and electrically coupled to one of said plurality of power converters.

21. The integrated mobile power station of claim 20 further comprising a controller mounted to said movable support structure, said controller being operably coupled to said generator, said plurality of power converters and said at least one transformer, said controller being configured to connect to a computer network.

22. The integrated mobile power station of claim 21 wherein said heat exchanger is coupled to said generator.

23. The integrated mobile power station of claim 22 wherein said heat exchanger includes means for transferring heat to an external load.

24. The integrated mobile power station of claim 23 wherein said external load is a building.

25. The integrated mobile power station of claim 21 further comprising a plurality of power output points, each of said plurality of power output points being electrically coupled to one of said plurality of power converters.

26. The integrated mobile power station of claim 25 wherein said mobile support means selected from the group consisting of trucks, trailers, tractor-trailers, rail cars, barges, ships, and aircraft.
